(19) United States
(12) Patent Application Publication
(10) Pub. No.: US 2021/0357196 A1
(43) Pub. Date: Nov. 18, 2021

(54) Automated Deployment of Analytic Models

(71) Applicant: Baker Hughes Oilfield Operations LLC, Houston, TX (US)

(72) Inventors: Bharathi Shekar, Bangalore (IN); Rohit Vineet, Bangalore (IN); Aravind Umasankar, Tamil Nadu (IN)

(21) Appl. No.: 15/931,852

(22) Filed: May 14, 2020

(51) Int. Cl. G06F 8/60; G06N 20/00; G06F 9/50

(52) U.S. Cl. CPC G06F 8/60; G06F 9/5011; G06N 20/00

(57) ABSTRACT

A method includes receiving data characterizing a request to execute an analytic model. The analytic model can include an executable representation associated with a physical system. The method can also include determining, based on the request, a deployment type associated with the analytic model. The deployment type can characterize temporal and computing resource requirements for executing the analytic model using a plurality of computing resources. The method can also include providing the deployment type, deploying the analytic model based on the deployment type, and executing the analytic model. Related systems, techniques, and non-transitory computer readable mediums are also described.

### BACKGROUND

Analytic models can be configured to emulate physical systems or components of physical systems in a variety of different industries. The analytic models allow engineers, scientists, and/or operators of the physical systems to evaluate operations and performance of the physical system and to predict future operations or performance prior to manufacturing and deploying the physical system in a real-world setting. The analytic models can also provide engineers, scientists, and/or operators of the physical systems insight about potential failures of the physical systems operation when the physical system is already live in an operational environment. An analytic model and/or a group of analytic models can be configured to reflect hierarchical or interdependent relationships between physical systems or the components of the physical systems. In one example, analytic models can be utilized in a fluid production environment, such as an oil and gas production environment, to make assessments and to generate analysis data associated with wells, well pumps, motors, or the like, prior to installation of such physical systems in the fluid production environment. Analytic models can be utilized in a number of other industries and/or domains, without limitation.

Cloud-based computing environments can provide on-demand availability for physical and virtual computing resources, which can be accessed via a network. Cloud-based computing environments can be configured with hardware virtualization architectures and/or service-oriented architectures to provide computing resources for a variety of applications. Cloud-based computing environments can be configured with container-orchestration systems to automate deployment of the analytic models for execution via virtualized computing resources.

### SUMMARY

In an aspect, a method includes receiving data characterizing a plurality of analytic models. An analytic model included in the plurality of analytic models can be an executable representation associated with a physical system. The method can also include determining, based on the received data, a deployment type associated with an analytic model included in the plurality of analytic models. The deployment type can characterize temporal and computing resource requirements for executing the analytic model using a plurality of computing resources. The method can further include deploying the analytic model on one or more computing resources of a plurality of computing resources based on the determined deployment type. The method can also include receiving data characterizing a request to execute an analytic model. The request can identify the analytic model to be executed. The method can further include executing the analytic model based on the deployment type.

One or more of the following features can be included in any feasible combination. For example, determining the deployment type can further include determining a deployment score associated with the analytic model. The deployment score can characterize a historical request frequency and a historical deployment performance of the analytic model as a function of historical execution time of the analytic model. Determining the deployment score can include determining a quotient of a number of received model execution requests associated with each analytic model in the plurality of analytic models multiplied by an amount of time to deploy the analytic model during an initial execution of the analytic model divided by an average execution time of the analytic model.

The method can also include determining a deployment order of the plurality of analytic models based on the deployment score determined for the analytic model, and deploying an analytic model with a higher deployment score first. The analytic model with the higher deployment score can be first deployed to a first portion of the one or more computing resources which can be permanently reserved. The analytic model with a lower deployment score can be later deployed to a second portion of the one or more computing resources which are not permanently reserved. Deploying the analytic model on the one or more computing resources of the plurality of computing resources can further include determining a number of the one or more computing resources required to execute the analytic model. The number of the one or more computing resources can be equal to or less than a percentage of total available computing resources.

The physical system can be configured within a fluid production environment. The physical system can include one of a well, a motor, a pump, a compressor, a driller, a mechanical component, a mechanical system, an electrical component, an electrical system, an electro-mechanical component, and an electro-mechanical system, or the like. The analytic model included in the plurality of analytic models and the plurality of analytic models can be configured with an execution sequence corresponding to an operation of the physical system. The analytic model can include one of a reservoir model, a pipe model, an electric submersible pump model, and a well head model.

The deployment type can be periodically determined based on at least one of a number of prior executions of the analytic model within a pre-determined time period, an average amount of time to deploy the analytic model, an average amount of time to execute the analytic model, an average number of data points associated with input parameters of prior successful executions of the analytic model, and a number of new data points associated with input parameters of a pending execution of the analytic model. The deployment type can include one of an on-demand deployment type configured to cause the analytic model to execute immediately following processing of the request and deployment of available computing resources capable of executing the analytic model from the plurality of computing resources, and a resource-dependent deployment type configured to cause the analytic model to execute immediately following processing of the request via previously provisioned computing resources capable of executing the analytic model, the previously provisioned computing resources included in the plurality of computing resources.

At least one of the receiving, the determining, the deploying, and the executing steps can be performed by a processor of a deployment analyzer module included in a model deployment system configured within a container-orchestration system, the deployment analyzer module configured to deploy, execute, and monitor the analytic models.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

### DESCRIPTION OF DRAWINGS

These and other features will be more readily understood from the following detailed description taken in conjunction with the accompanying drawings, in which:

FIG. 1 illustrates an example process for deploying and executing an analytic model in a model deployment system; and

FIG. 2 illustrates a system block diagram of an example model deployment system according to some implementations of the current subject matter.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Analytic models of physical systems are used to assess and predict the operation of physical systems or components which are modeled using the analytic models. Analytic models can be written in different programming languages and can require unique inputs, configurations, and datasets to execute. In traditional systems to deploy and execute analytic models, a data scientist or engineer is typically required to have prior knowledge of the configuration of the computing resources on which the analytic models will be executed. The data scientist or engineer may also be required to specify how the model should be deployed. For example, the data scientist or engineer may need to specify whether an analytic model requires computing resources to be deployed for model execution, such as in an on-demand-type deployment, or if the analytic model should be deployed with using previously provisioned or deployed computing resources, such as in a resource-dependent deployment type. The data scientist or engineer may select a particular deployment type for an analytic model based on approximate estimates of the computing resources required to execute the model, such as CPU, RAM, or a number of execution nodes and not based on the real-time execution requirements of the model. As a result, the computing resources to be deployed and used to execute the model may not be used in an efficient or optimized manner.

For example, executing an analytic model with a resource-dependent deployment type in traditional model deployment systems can delay the time to initiate execution of the model because there may be a lack of dedicated or previously deployed computing resources configured to execute the model. The delay can be further exacerbated as additional requests to execute the analytic model are received. Additionally, executing an analytic model with an on-demand deployment type in traditional model deployment systems can also delay time to execution when incoming requests are associated with analytic models configured with a resource-dependent deployment type due to a lack of previously assigned or deployed computing resources available to process the analytic model having the on-demand deployment type.

In traditional model deployment systems, users, such as data scientists, model developers, engineers, and/or operators of the physical systems seeking to execute an analytic model do not usually have knowledge of the performance capabilities or deployment configurations of the computing resources they seek to use to execute the analytic model. As a result, users may be unable to manipulate the configuration of the computing resources in a timely manner required to execute an analytic model. This can cause a cluster of computing resources to be managed and configured in a sub-optimal or even under-performing configuration which can affect other users seeking to execute analytic models using the same cluster of computing resources.

In some implementations, the current subject matter includes an approach to model deployment. The model deployment approach can automatically optimize the deployment type and the computing resources available to execute an analytic model without requiring a user to identify a deployment type in advance of executing the analytic model. Some implementations of the approach to model deployment thus can alleviate the need for users to specify a deployment type for a particular analytic model and users can achieve a more satisfying user experience when configuring, deploying, and executing an analytic model compared to traditional model deployment systems. The approach to model deployment described herein can provide faster model deployment, faster model execution, and more rapid generation of model results compared to some traditional model deployment systems. And such improvements can improve safety when modeling operationally-critical models which may need to be deployed and executed frequently to ensure the physical system corresponding to the analytic model is operating as expected.

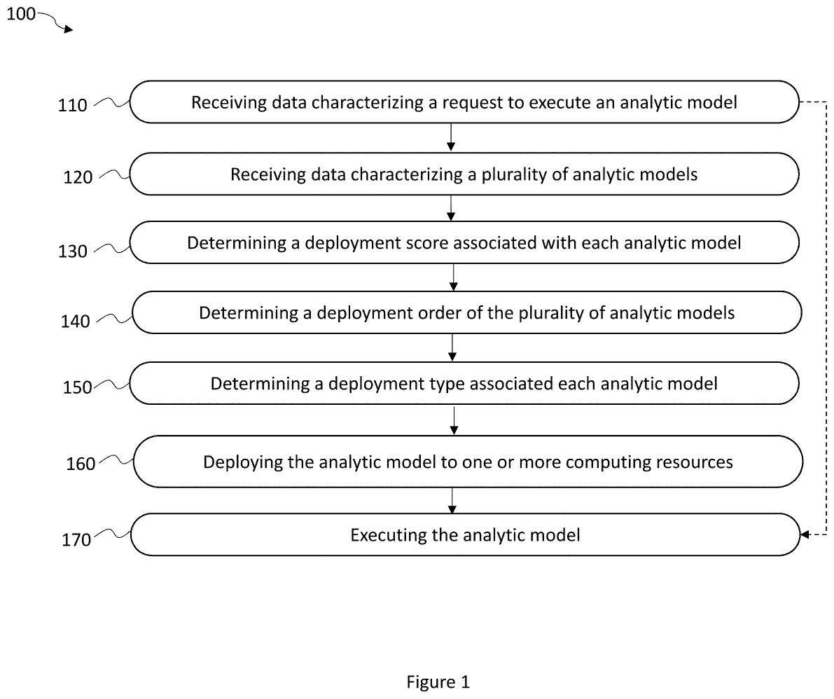

FIG. 1 is a process flow diagram illustrating an example process 100 for deploying and executing an analytic model in a model deployment system. Deployment and execution of the analytic model can be automated and optimized by performing operations of the example process 100. In some embodiments, steps of the method 100 can be performed asynchronously from or in parallel with other steps of the method 100. For example, as shown by the dashed line connecting step 110 and step 170 can be performed asynchronously from or in parallel with steps 120-160. In this example, an analytic model can be executed in the model deployment system based on data characterizing a request to execute an analytic model. In other embodiments, the steps 120-160 can be performed asynchronously from or in parallel with steps 110 and 170. For example, steps 120-160 can be performed at periodic intervals and can be performed independently of steps 110 and 170.

At 110, data characterizing a request to execute an analytic model can be received by a model deployment system. The request can include data identifying the analytic model to be executed and can further include one or more data sets associated with the analytic model. In some embodiments, the data characterizing the request can include a unique identifier identifying the analytic model to be executed, for example when a new analytic model is to be deployed and executed for the first time. In some embodiments, the data characterizing the request can include the analytic model itself or a pointer to a file location storing the executable model. The analytic models can be configured to receive data sets as inputs and can be configured to generate data sets as outputs.

The analytic model can include an executable representation of a physical system or a component of a physical system. Examples of the physical system can include, without limitation, a well, a motor, a pump, a compressor, a driller, or any similar electro-mechanical equipment of the fluid production environment or an oil and gas production environment. In some embodiments, the analytic models can include deep learning based models, artificial neural network models, and/or machine learning based models.

In some embodiments, the analytic model can include an executable representation of multiple related physical systems. For example, the analytic model can be a model of a well configured in an in an oil and gas production environment and used to extract oil or gas from a well site. The well can include a number of different, interrelated physical systems to extract the oil or gas, such as an electric submersible pump (ESP), a well head pump, a compressor, and a hydraulic valve. Each of these components of the well can be modeled with an analytic model. A group of analytic models representing different physical systems can be organized into a single analytic model. The hierarchical arrangement or inter-dependent relationships of the physical systems can be reproduced in an analytic model, which includes multiple individual analytic models. In some embodiments, multiple related physical systems can be represented as a model or a plurality of models. The model or plurality of models can be configured to execute in a sequence or order corresponding to the inter-related operation of the physical systems that the model or plurality of models represents. In this way, a fluid pressure measured via an ESP can be provided as an output of an analytic model of the ESP. The fluid pressure measurement that is output by the ESP analytic model can be provided as an input to a well head pump analytic model, which can replicate the operation of the ESP and the well head pump in real-world operation. In some embodiments, the execution sequence can be a linear model execution sequence. In some embodiments, the execution sequence can include or specify execution of models in parallel. For example an execution sequence can require a first model, model A, to execute in parallel with a second model, model B. The outputs of model A and model B can be provided as inputs to a third model, model C.

A request to execute an analytic model can be provided by an engineer, scientist, operator, or similar personnel associated with the oil and gas production environment (or a user of the model deployment system) wishing to evaluate, test, or assess the physical system using the analytic model. In some embodiments, a computing device configured within or communicatively coupled to the model deployment system can provide data characterizing the request to execute the analytic model.

At 120, the model deployment system can receive data characterizing a plurality of analytic models. The model deployment system can receive or request a list of all analytic models configured within the model deployment system.

At 130, a deployment score can be determined for each analytic model included in the plurality of analytic models received or requested in step 120. The deployment score can be determined based on a number of non-limiting factors. For example, a deployment score for an analytic model can be based on a number of execution requests that have been received in an amount of time, such as a number of requests received per minute within the past hour, 12 hours, 24 hours, day, days, week, month, or the like. Additionally, the deployment score can be determined based on an amount of time it took for the analytic model to execute for the first time. In this way, a baseline performance execution can be established for the analytic model. The deployment score can also be determined based on historical execution of the model and/or based on an amount of time taken to execute the model in the past. For example, a deployment score for an analytic model can be based on an amount of time for the model to execute in the past hour, 12 hours, 24 hours, day, days, week, month, or the like. The time periods associated with determining the deployment score are not-limited to those described above and can be pre-determined. In some embodiments, the deployment score can be determined based on a combination of one or more factors described above. In one non-limiting example, a deployment score can be determined as a quotient of a number of received execution requests multiplied by an amount of time to deploy the analytic model during an initial execution of the analytic model divided by an average execution time of the analytic model. In some embodiments, the analytic model with the highest deployment score can be executed first.

At 140, a deployment order of the plurality of analytic models can be determined, based on the deployment score. The deployment score allows sorting or ordering the analytic models in a descending order, such that analytic models with a higher deployment score are listed first in a list of models and analytic models with a lower deployment score are listed later or last in the ordered list compared to analytic models which have a higher deployment score. The determined deployment order can be utilized to assign computing resources to execute a deployed analytic model. In this way a sequence of execution for analytic models can be determined based on the deployment order.

At 150, the model deployment system can determine a deployment type associated with each the analytic model. Analytic models which include a higher deployment order (and thus have been determined to have a higher deployment score) can have their deployment type set such that these analytic models are deployed on computing resources which are permanently reserved. Analytic models which include a lower deployment order (and thus have been determined to have a lower deployment score) can have their deployment type set such that these analytic models are deployed on computing resources which are not reserved and are available based on need.

The deployment type can characterize temporal requirements for executing the model. For example, the deployment type can include data describing when the model should run, such as immediately, or when sufficient computing resources become available for model execution. The deployment type can also include data describing the computing resources are required to execute the model at run-time, such as CPU, memory, datasets, applications, or the like. In some embodiments, the deployment type can include an on-demand deployment type. Executing the model with an on-demand deployment type can cause the model to be executed immediately following processing of the request to execute the model and following deployment of available computing resources that are capable of executing the model. Models which include an on-demand deployment type require deployment of computing resources such as CPU, memory or RAM, and nodes of the computing environment prior to model execution on the nodes. Computing resources associated with models having an on-demand deployment are made available on a need basis for a temporary period of time. The need to consume computing reserves occurs only when an analytic model having an on-demand deployment type needs to be executed/processed. As soon as the processing/execution has completed, the computing resources are released. For example, the computing resources can be released for execution of other analytical models. In this way, models which can include an on-demand deployment type can have an impact on the overall computing performance of the total computing resources available within the computing environment to execute the analytic models. Analytic models determined to have an on-demand deployment type may include high-priority, safety-critical, models associated with physical systems that are important to monitor within the fluid production environment or oil and gas production environments on a frequent basis.

In some embodiments, the deployment type of an analytic model can also include a resource-dependent deployment type. A model having a resource-dependent deployment type can execute immediately following processing of the request to execute the model. Further, a model having a resource-dependent deployment type can be run only via previously provisioned computing resources, such as CPU, RAM, and nodes which have been assigned to a particular analytic model. For example, the resource-dependent deployment type can cause the model to execute via previously assigned or dedicated computing resources included in a number of total available computing resources. Analytic models which can include a resource-dependent deployment type can execute faster because there is no need to deploy CPU, RAM, and/or nodes to execute the analytic model, but models with this deployment type can also reduce the number of total available computing resources that are available to execute analytic models that have an on-demand deployment type. Computing resources associated with analytic models having a resource-dependent deployment type can be reserved permanently and the same resources may not be available for other analytic models. Whenever an analytic model having a resource-dependent deployment type must be executed/processed, the computing resources are ready and available to allow the analytical model to complete processing/executing quickly. Analytic models determined to have an resource-dependent deployment type may include analytic models, which can have unique hardware, software, network, application, data, or I/O requirements. For example, an particular data set, processor type, virtual machine, pod, or container configuration may be a required computing resource necessary to execute an analytic model including a resource-dependent deployment type.

A container-orchestration system can automate the deployment, management, scaling, and networking of containers. A container can include a set of one or more processes that can be isolated from the rest of the system. All the files necessary to run the processes in the container are provided from a distinct image, meaning that containers can be portable and can be consistent as they are used within different deployment environments. Container orchestration can be used in any environment where containers are in use. Containers can help deploy the same application across different environments without having to redesign the application for any one particular environment. Kubernetes is an example of an open-source system for automating deployment scaling, and management of containerized applications. Microservices within containers can make it easier to orchestrate services, including storage, networking, and security. Containers can provide microservice-based applications with an ideal application deployment unit and a self-contained execution environment. Containers can make it possible to run multiple parts of an application independently in microservices, on the same hardware, with much greater control over individual pieces and life cycles.

The deployment type of an analytic model can be periodically determined based on a number of non-limiting factors, such as the model's historical execution, deployment speed, execution performance, execution frequency, and/or complexity. For example, in some embodiments, the deployment type can be determined based on a number of previous executions of the model that have occurred within a pre-determined time period, such as a number of times a minute, an hour, a day, or a week that the model has previously been executed.

In some embodiments, the deployment type of the analytic model can be determined based on an average amount of time to deploy the analytic model. For example, analytic models determined to include an on-demand deployment type may be deployed slower than analytic models including a resource-dependent deployment type since analytic models determined to have an on-demand deployment type are not associated with dedicated computing resources and thus must wait to execute until sufficient computing resources have been deployed from a total number of available computing resources. As a result, the average time for model deployment can be slower for some analytic models compared to others.

In some embodiments, the deployment type of the analytic model can be determined based on an average amount of time to execute the analytic model. For example, it may be more beneficial to determine that a slowly executing model include a resource-dependent deployment type so that a dedicated number of additional or faster computing resources could be assigned to execute slower analytic models. Additionally, the time required to deploy the computing resources prior to model execution can exacerbate the overall time required for model execution.

In some embodiments, the deployment type can be determined based on an average number of data points associated with prior successful executions of the analytic model. For example, an analytic model requiring large numbers of data points to successfully execute in the past may be determined to include a resource-dependent deployment type, instead of an on-demand deployment type, since dedicated computing resource associated with models having a resource-dependent deployment type can be configured with additional memory, processors, nodes, cores, pods, or containers necessary to accommodate the size of the data necessary to successfully execute the model.

In some embodiments, the deployment type can be determined based on a number of new data points which are associated with new input parameters of a pending execution of the analytic model. If an analytic model has changed since past executions to subsequently require new or additional input parameters, as well as new or additional data or data points, the analytic model may not be suitable for deployment as an on-demand deployment type because the new input parameters could require a unique configuration of processor, memory, or data, that is not present within or associated with the computing resources that are available to execute analytic models of an on-demand deployment type.

In addition to the factors described above used for determining the deployment type, a deployment score can be used to determine the deployment type. Each analytic model be associated with a deployment score which can be used to create a ranked order for deploying analytic models. The deployment score can characterize an analytic model in terms of the frequency of past execution requests, the performance of past deployments, and/or the amount of time it took for the analytic model to execute in the past.

At 160, the analytic model can be deployed to one or more computing resources based on the deployment type. In some embodiments, the analytic model can be re-deployed to a new or alternate number of computing resources which are different from the computing resources to which the analytic model may have been previously or initially deployed. The analytic model can be deployed to computing resources determined from a plurality of total available computing resources. For example, an analytic model including a resource-dependent deployment type can be deployed to computing resources which are dedicated to and associated with the analytic model. These computing resources are thus unavailable for deployment for an analytic model including an on-demand deployment type. Similarly, an analytic model including an on-demand deployment type can be deployed once the system has determined the computing resource requirements necessary to execute the analytic model. Once the analytic model has been deployed to the determined computing resources, the determined computing resources can be unavailable to execute an analytic model deployed with a resource-dependent deployment type. In addition, the computing resources available to execute models including an on-demand deployment type can lack the appropriate CPU, memory, data, and/or like computing resource features or configurations necessary for execution of models including an resource-dependent deployment type. In some embodiments, the analytic model can be deployed such that the analytic model with a highest deployment score is deployed to a percentage of the computing resources. In this way, the total available computing resources can be managed and optimized in conjunction with managing and optimizing the deployment (and execution) of the analytic model with the highest deployment score. In some embodiments, the analytic model can be deployed to number of computing resources is equal to or less than a percentage of total available computing resources. Thus, both computing resource availability and the deployment and execution requirements of a given model can be accounted for when determining computing resources to assign for model execution.

The deployment type can be provided for use within the model deployment system. In some embodiments, providing the deployment type can include storing the deployment type associated with each analytic model. The deployment type can be associated with an analytic model as an attribute, meta-data, and/or configuration data. In some embodiments, the deployment type can be provided to a service or computing device for use in executing the analytic model via the assigned computing resources. In some embodiments, the deployment type can be provided to a user via a graphical user interface or via a display of a computing device.

At 170, the analytic model can be executed. The analytic model can be executed on the computing resources to which it was deployed and for which the computing resource were deployed to perform the execution of the analytic model. The deployed analytic model can be executed base on the determined deployment type to generate analysis data, predictions, and/or assessments related to the physical system associated with the analytic model.

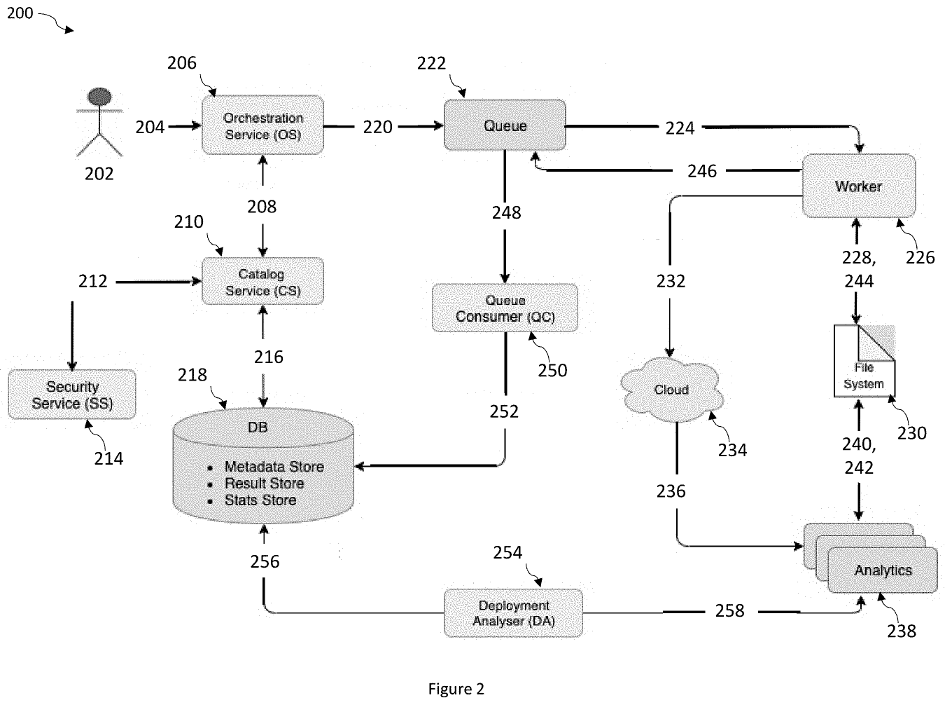

FIG. 2 illustrates a system block diagram of an example model deployment system 200 according to some implementations described herein. The flow of data between components of the model deployment system, shown as enumerated arrows between components, is also illustrated in FIG. 2. The model deployment system 200 shown in FIG. 2, performs the operations of method 100 of FIG. 1, except where described otherwise.

The model deployment system 200 of FIG. 2 can be included in a computing environment of the fluid production environment. For example, the model deployment system 200 can be configured to store, deploy, execute, and manage analytic models corresponding to physical systems or physical components associated with the production of oil and/or gas. The fluid production environment can include a computing environment for requesting deployment and execution of analytic models.

The model deployment system 200 can be configured as a container-orchestration system to automate model deployment and configuration of computing resources. The model deployment system 200 can include computing resources such as pods which can consist of one or more containers co-located on a host computing device and capable of sharing the CPU, RAM, data, and file systems of the host computing device. Pods can have a unique IP address within a cluster of pods. A pod can define a storage component, such as a local disk directory or a network disk, that can exchange data with the containers in the pod. Pods can work together to perform a service which can be exposed to the containers as well as to other pods. In some embodiments, the model deployment system 200 can be configured using a Kubernetes container-orchestration system provided by the Cloud Native Computing Foundation and written in the Go programming language.

As shown in FIG. 2, a user 202, such as an engineer, scientist, or operator associated with the model deployment system 200. The user 202 can be a registered user of the model deployment system 200, such as a customer of the fluid production system or a manufacturer of one or more physical systems of an oil and gas production environment. The user 202 can submit a request 204 to execute an analytic model to an orchestration service 206.

The orchestration service 206 is a micro-service configured to execute processing of the request by selecting the requested analytic model from a group of analytic models. The analytic models can be written in one or more different programming languages and stored in a directed acyclic graph. The orchestration service 206 can be communicatively coupled to a catalog service 210. The orchestration service 206 can query and receive metadata 208 from the catalog service 210. The catalog service 210 can include a micro-service configured to fetch metadata from a persistent data store, such as database 218 or from a security service 214. For example, the orchestration service 206 can authenticate user 202 and the user's request 204 to execute an analytic model by requesting authentication processing via the catalog service 210 from the security service 214. The security service 214 can include a micro-service configured to validate the user 202 as an authenticated user of the model deployment system 200. The security service 214 can validate the user's permission to create, submit, and execute a request to execute an analytic model. The validation data 212 can be provided to the orchestration service 206 to allow processing of the request 204. The catalog service 210 can further query for and collect additional metadata 216 which may be required or associated with the request, the deployment of the model, and/or the execution of the model from a database 218. The database 218 can be a relational database and can store metadata, model execution results, and analysis data associated with the execution and/or deployment of one or more analytic models configured in the model deployment system 200. The metadata, model execution results, and analysis data 216 can be provided to the orchestration service 206 for use in processing the request 204.

The orchestration service 206 can create a task and can transmit the task 220 to a queue 222. The task can include the request 204 to execute an analytic model, as well as any necessary datasets or configuration data necessary properly deploy and execute the analytic model identified in the request 204. The queue 222 can be configured with messaging protocols such as an advanced message queueing protocol to process the requests 204. In some embodiments, the queue 222 can be configured as a plug-in architecture and can support streaming text oriented messaging protocol, message queueing telemetry transport protocol, and the like.

The tasks 220 in queue 222 are read 224 from the queue by worker 226. The worker 226 is a micro-service configured to query the queue 222, read the tasks 220, and deploy the task 220 at run-time in the model deployment system 200. The worker 226 can also monitor the deployment and execution of the analytic model and generate analytic data associated with the deployment and execution of the analytic model until the completion of model execution. The worker 226 can write analytic data 228 associated with the deployment and execution of the analytic model to a file system 230. The worker 226 can also deploy 232 the analytic model identified in the task 220 to a plurality of computing resources configured in a cloud-computing environment 234. In some embodiments, the cloud-computing environment 234 can include physical hardware such as a plurality of dedicated servers hosted in a data center. In some embodiments, the cloud-computing environment 234 can include a plurality of virtualized computing resources, such as virtual machines. In some embodiments, the cloud-computing environment 234 can include a container-orchestration system, such as a Kubernetes environment, including a plurality of pods and containers. The cloud-computing environment 234 can be configured to deploy and manage analytic models and the computing resources necessary or determined to be used to execute the analytic model identified in the task 220.

The cloud-computing environment 234 deploys 236 the analytic models 238 for execution on a plurality of computing resources. The analytic models 238 can read input 240 from the file system 230 necessary for execution of the analytic model and can write output 242 of the model execution to the file system 230. The worker 236 can further read the output 244 from the file system 230. In this way, the file system 230 can act as a persistent datastore of files and data associated with inputs to the analytic models and output from the analytic models. The file system 230 can act as a common data store for both the analytic models and the worker 226. The worker 226 can provide the output as a result 246 to the queue 222. A queue consumer 250 can receive 248 the output of model execution from the queue 222. The queue consumer 250 can be configured as a micro-service to consume results of analytic model execution from the queue 222 and provide 252 the results of analytic model execution to the database 218. The results can be written to a results store configured within the database 218.

The model deployment system 200 can also include a deployment analyzer 254. The deployment analyzer 254 can be configured as an asynchronous component and/or micro-service to determine a deployment type for each analytic model as described in operation 120 of FIG. 1. The deployment analyzer 254 can further determine a deployment score for each analytic model as described in operation 130 of FIG. 1. In some embodiments, the deployment score can be determined on a particular time schedule, such as every minute, hour, day, or week. In some embodiments, the deployment score can be determined based on one or more changes of the input parameters of the analytic model. The deployment analyzer 254 can also provide 256 the deployment type and the deployment score to a stats store configured within the database 218.

The deployment analyzer 254 can provide 258 updated deployment types to the analytic models 238 and cause the analytic models to be deployed for execution based on the determined deployment type. The deployment analyzer 254 can sort each analytic model in a descending order of execution based on the determined deployment score. The deployment analyzer 254 can determine a number of pods that all analytic models 238 require to execute. The deployment analyzer 254 can assign a percentage of available pods to analytic models which have the highest deployment score. The deployment analyzer 254 can select models where the total number of required pods is equal to or less than a percentage of all available pods. In some embodiments, the deployment analyzer 254 can determine the computing resource requirements, such as CPU, and/or RAM, required to execute the analytic models which have been selected to execute based on the deployment score. The deployment analyzer 254 can modify the deployment type for a particular analytic model. For example, the deployment analyzer 254 change the deployment type for analytic models configured with an on-demand deployment type to a resource-dependent deployment type based on the processing performed by the deployment analyzer 254 in regard to the method described in FIG. 1.

The updated deployment type of an analytic model can be stored in the database 218 and can be received by the orchestration service 206 when a request 204 is received to execute an analytic model. In this way, the deployment analyzer 254 can dynamically determine deployment types for analytic models such that the available computing resources are optimized based on the number of requests to execute a particular analytic model.

Exemplary technical effects of the methods, systems, and computer-readable medium described herein include, by way of non-limiting example, determining a deployment type for an analytic model to be deployed in a model deployment system. The deployment type can be automatically determined based on a deployment score associated with a number of requests to execute an analytic model and available computing resources. The model deployment system can provide improved resource allocation and configuration of the computing resources thereby maximizing the availability of individual computing resources and the overall execution performance of a total number of computing resources. The model deployment system can provide a deployment mechanism for deploying analytic models based on their deployment score. Thus the model deployment systems and interfaces described herein improve the operation of computing devices configured to deploy analytic models in a container-orchestration system.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment can be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, can be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language can correspond to the precision of an instrument for measuring the value. Here and throughout the specification and claims, range limitations can be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A method comprising:
receiving data characterizing a plurality of analytic models, wherein an analytic model included in the plurality of analytic models is an executable representation associated with a physical system;
determining, based on the received data, a deployment type associated with an analytic model included in the plurality of analytic models, the deployment type characterizing temporal and computing resource requirements for executing the analytic model using a plurality of computing resources; and
deploying the analytic model on one or more computing resources of a plurality of computing resources based on the determined deployment type.

2. The method of claim 1, further comprising receiving data characterizing a request to execute an analytic model, the request identifying the analytic model to be executed and executing the analytic model based on the deployment type.

3. The method of claim 1, wherein determining the deployment type further comprises determining a deployment score associated with the analytic model.

4. The method of claim 3, wherein the deployment score characterizes historical request frequency and historical deployment performance of the analytic model as a function of historical execution time of the analytic model.

5. The method of claim 3, wherein determining the deployment score includes determining a quotient of a number of received model execution requests associated with each analytic model in the plurality of analytic models multiplied by an amount of time to deploy the analytic model during an initial execution of the analytic model divided by an average execution time of the analytic model.

6. The method of claim 3, further comprising determining a deployment order of the plurality of analytic models based on the deployment score determined for the analytic model, and deploying an analytic model with a higher deployment score first.

7. The method of claim 6, wherein the analytic model with the higher deployment score is first deployed to a first portion of the one or more computing resources which are permanently reserved.

8. The method of claim 7, wherein an analytic model with a lower deployment score is later deployed to a second portion of the one or more computing resources which are not permanently reserved.

9. The method of claim 1, wherein deploying the analytic model on the one or more computing resources of the plurality of computing resources further comprises determining a number of the one or more computing resources required to execute the analytic model, such that a number of the one or more computing resources is equal to or less than a percentage of total available computing resources.

10. The method of claim 1, wherein the physical system is configured within a fluid production environment.

11. The method of claim 1, wherein the physical system includes one of a well, a motor, a pump, a compressor, a driller, a mechanical component, a mechanical system, an electrical component, an electrical system, an electro-mechanical component, and an electro-mechanical system.

12. The method of claim 1, wherein the analytic model included in the plurality of analytic models and the plurality of analytic models are configured with an execution sequence corresponding to an operation of the physical system.

13. The method of claim 1, wherein the analytic model includes one of a reservoir model, a pipe model, an electric submersible pump model, and a well head model.

14. The method of claim 1, wherein the deployment type is periodically determined based on at least one of a number of prior executions of the analytic model within a pre-determined time period, an average amount of time to deploy the analytic model, an average amount of time to execute the analytic model, an average number of data points associated with input parameters of prior successful executions of the analytic model, and a number of new data points associated with input parameters of a pending execution of the analytic model.

15. The method of claim 1, wherein the deployment type includes one of an on-demand deployment type configured to cause the analytic model to execute immediately following processing of the request and deployment of available computing resources capable of executing the analytic model from the plurality of computing resources, and a resource-dependent deployment type configured to cause the analytic model to execute immediately following processing of the request via previously provisioned computing resources capable of executing the analytic model, the previously provisioned computing resources included in the plurality of computing resources.

16. The method of claim 1, wherein at least one of the receiving, the determining, the deploying, and the executing steps are performed by a processor of a deployment analyzer module included in a model deployment system configured within a container-orchestration system, the deployment analyzer module configured to deploy, execute, and monitor the analytic models.

17. A system comprising:
at least one data processor; and
memory storing instructions, which when executed by at the least one data processor causes the at least one data processor to perform operations comprising:
receiving data characterizing a plurality of analytic models, wherein an analytic model included in the plurality of analytic models is an executable representation associated with a physical system;
determining, based on the received data, a deployment type associated with an analytic model included in the plurality of analytic models, the deployment type characterizing temporal and computing resource requirements for executing the analytic model using a plurality of computing resources; and
deploying the analytic model on one or more computing resources of a plurality of computing resources based on the determined deployment type.

18. The system of claim 17, wherein the at least one data processor further performs operations comprising receiving data characterizing a request to execute an analytic model, the request identifying the analytic model to be executed and deploying the analytic model based on the deployment type.

19. The system of claim 17, wherein determining the deployment type further comprises determining a deployment score associated with the analytic model.

20. A non-transitory computer readable medium storing instructions, which when executed by at least one data processor cause the at least one data processor to perform operations comprising:
receiving data characterizing a plurality of analytic models, wherein an analytic model included in the plurality of analytic models is an executable representation associated with a physical system;
determining, based on the received data, a deployment type associated with an analytic model included in the plurality of analytic models, the deployment type characterizing temporal and computing resource requirements for executing the analytic model using a plurality of computing resources; and
deploying the analytic model on one or more computing resources of a plurality of computing resources based on the determined deployment type.
